(19) United States
(12) Patent Application Publication
(10) Pub. No.: US 2016/0205738 A1
(43) Pub. Date: Jul. 14, 2016

(54) LED TUBE ADAPTED FOR USE WITH ELECTRONIC BALLAST OR AC MAINS AND CONTROLLING METHOD THEREOF

(71) Applicant: Asiatree Technology Co., Ltd., Tainan City (TW)

(72) Inventor: Bing-Huang Lee, Tainan City (TW)

(21) Appl. No.: 14/710,127

(22) Filed: May 12, 2015

(30) Foreign Application Priority Data
Jan. 8, 2015 (TW) 104100586

(51) Int. Cl. H05B 33/08; F21K 99/00

(52) U.S. Cl. CPC H05B 33/0845; F21K 9/17; H05B 33/0809

(57) ABSTRACT

An LED tube adapted for use with an electronic ballast and a controlling method thereof are disclosed. The proposed LED tube includes a filament simulation circuit electrically connected to the electronic ballast and a fluorescent lamp tube simulation circuit electrically connected to the filament simulation circuit and including a plurality of LEDs and a lamp tube voltage simulation circuit, wherein the lamp tube voltage simulation circuit is electrically connected to the plurality of LEDs in series.

### CROSS-REFERENCE TO RELATED APPLICATION

This application claims the benefit of Taiwan Patent Application Number 104100586 filed on Jan. 8, 2015, at the Taiwan Intellectual Property Office, the disclosure of which is incorporated herein in its entirety by reference.

### FIELD OF THE INVENTION

The present invention relates to a light-emitting diode (LED) tube adapted for use with an electronic ballast or AC mains and controlling method thereof, in particular to an LED tube including a filament simulation circuit and a fluorescent lamp tube simulation circuit, and adapted for use with an electronic ballast or AC mains, and controlling method thereof.

### BACKGROUND OF THE INVENTION

The main electronic ballasts on the market can be divided into three categories: 1. preheat electronic ballast, 2. instant-start electronic ballast, and 3. rapid-start electronic ballast. FIG. 1(a) shows a schematic circuit diagram of a fluorescent lamp system 1 including a preheat electronic ballast 11. As shown in FIG. 1(a), the preheat electronic ballast 11 includes an active PFC stage 111 and a first half-bridge resonant tank 112. In FIG. 1(a), the fluorescent lamp system 1 further includes a fluorescent lamp tube 12 and an AC power source 13, the preheat electronic ballast 11 will preheat the filaments via a small current and then start the fluorescent lamp tube 12. FIG. 1(b) shows a schematic circuit diagram of a fluorescent lamp system 2 including an instant-start electronic ballast 21. As shown in FIG. 1(b), the instant-start electronic ballast 21 includes a passive PFC stage 211 and a second half-bridge resonant tank 212. In FIG. 1(b), the fluorescent lamp system 2 also includes the fluorescent lamp tube 12 and the AC power source 13, and the instant-start electronic ballast 21 will provide a high voltage and then start the fluorescent lamp tube 12. FIG. 1(c) shows a schematic circuit diagram of a fluorescent lamp system 3 including a rapid-start electronic ballast 31. As shown in FIG. 1(c), the rapid-start electronic ballast 31 includes a passive PFC stage 311 and a third half-bridge resonant tank 312. In FIG. 1(c), the fluorescent lamp system 3 includes the fluorescent lamp tube 12 and the AC power source 13 as well, and the rapid-start electronic ballast 31 has auxiliary windings (Pl-P3), which continuously provide voltage to the filaments to provide heating current, and this design is more frequently used in Europe, the U.S. and Japan.

When an LED tube is used to replace a fluorescent lamp tube, there are problems regarding the removal of the original ballast and jumper wire. Specifically, if the fluorescent lamp tube can be replaced with the LED tube to match the electronic ballast, then it will greatly raise consumer acceptance because the electronic ballast is quite expensive. Thus, how to design an LED tube adapted for use with existing/commercially available electronic ballasts is worthy of further research and improvement.

Keeping the drawbacks of the prior art in mind, and through the use of robust and persistent experiments and research, the applicant has finally conceived of an LED tube adapted for use with an electronic ballast or AC mains and a controlling method thereof.

### SUMMARY OF THE INVENTION

It is an objective of the present invention to provide an LED tube for use with an electronic ballast or AC mains to replace the fluorescent lamp tube with a basic configuration using the characteristics of the electronic ballast adapted for use with a dual-fast bridge rectifier without changing the circuitry, wherein the LED tube includes a filament simulation circuit and a fluorescent lamp tube simulation circuit, the filament simulation circuit comprises the basic configuration, a capacitor connected to the basic configuration in parallel, or a resistor connected to the basic configuration in parallel, and the fluorescent lamp tube simulation circuit comprises LEDs, or LEDs adapted for use with a tube voltage simulation circuit so as to respond to the filament detection scheme and the tube voltage detection scheme within the electronic ballast.

In accordance with the first aspect of the present invention, an LED tube adapted for use with an electronic ballast comprises a filament simulation circuit including a first rectifier circuit having at least one of a first instance of two fast diodes and a second instance of two super fast diodes, and a second rectifier circuit having at least one of a first instance of two fast diodes and a second instance of two super fast diodes, wherein the electronic ballast includes a first lamp tube connector with a first terminal and a second terminal, and a second lamp tube connector with a third terminal and a fourth terminal, the first rectifier circuit is electrically connected to the first and the second terminals and the second rectifier circuit is electrically connected to the third and the fourth terminals.

In accordance with the second aspect of the present invention, an LED tube adapted for use with an electronic ballast comprises a filament simulation circuit electrically connected to the electronic ballast and a fluorescent lamp tube simulation circuit electrically connected to the filament simulation circuit and including a plurality of LEDs, and a lamp tube voltage simulation circuit electrically connected to the plurality of LEDs in series.

In accordance with the third aspect of the present invention, a controlling method for an LED tube adapted for use with an electronic ballast comprises: providing the electronic ballast having a specific operation mode and the LED tube having a simulation circuit; and causing the simulation circuit to simulate a resistance of a filament of a fluorescent lamp tube and a lamp tube voltage so as to respond to the specific operation mode accordingly such that the LED tube operates normally.

### BRIEF DESCRIPTION OF THE DRAWINGS

Other objectives, advantages and the efficacy of the present invention will be described in detail below taken from the preferred embodiments with reference to the accompanying drawings, in which:

FIG. 1(a) is a schematic circuit diagram of a fluorescent lamp system including a preheat electronic ballast.

FIG. 1(b) is a schematic circuit diagram of a fluorescent lamp system including an instant-start electronic ballast.

FIG. 1(c) is a schematic circuit diagram of a fluorescent lamp system including a rapid-start electronic ballast.

FIG. 2 is a schematic circuit diagram of a lamp including an electronic ballast and an LED replacement tube according to the first preferred embodiment of the present invention.

FIG. 3 is a schematic circuit diagram of a filament simulation circuit according to the second preferred embodiment of the present invention.

FIG. 4 is a schematic circuit diagram of a filament simulation circuit according to the third preferred embodiment of the present invention.

FIG. 5 is a schematic circuit diagram of a filament simulation circuit according to the fourth preferred embodiment of the present invention.

FIG. 6 is a schematic circuit diagram of a filament simulation circuit according to the fifth preferred embodiment of the present invention.

FIG. 7 is a schematic circuit diagram of a filament simulation circuit according to the sixth preferred embodiment of the present invention.

FIG. 8(a) is a schematic circuit diagram of a fluorescent lamp tube simulation circuit according to the seventh preferred embodiment of the present invention.

FIG. 8(b) is a schematic circuit diagram of a fluorescent lamp tube simulation circuit according to the eighth preferred embodiment of the present invention.

FIG. 8(c) is a schematic circuit diagram of a fluorescent lamp tube simulation circuit according to the ninth preferred embodiment of the present invention.

FIG. 8(d) is a schematic circuit diagram of a fluorescent lamp tube simulation circuit according to the tenth preferred embodiment of the present invention.

FIG. 9 is a schematic circuit diagram of a lamp including an LED replacement tube adapted for use with an electronic ballast or an AC mains and an AC isolation circuit according to the eleventh preferred embodiment of the present invention.

FIG. 10 is a schematic circuit diagram of a lamp including an LED replacement tube adapted for use with an electronic ballast or an AC mains and an AC isolation circuit according to the twelfth preferred embodiment of the present invention.

### DETAILED DESCRIPTION OF THE PREFERRED EMBODIMENT

The present invention will now be described more specifically with reference to the following embodiments. It is to be noted that the following descriptions of the preferred embodiments of this invention are presented herein for purposes of illustration and description only; they are not intended to be exhaustive or to be limited to the precise form disclosed.

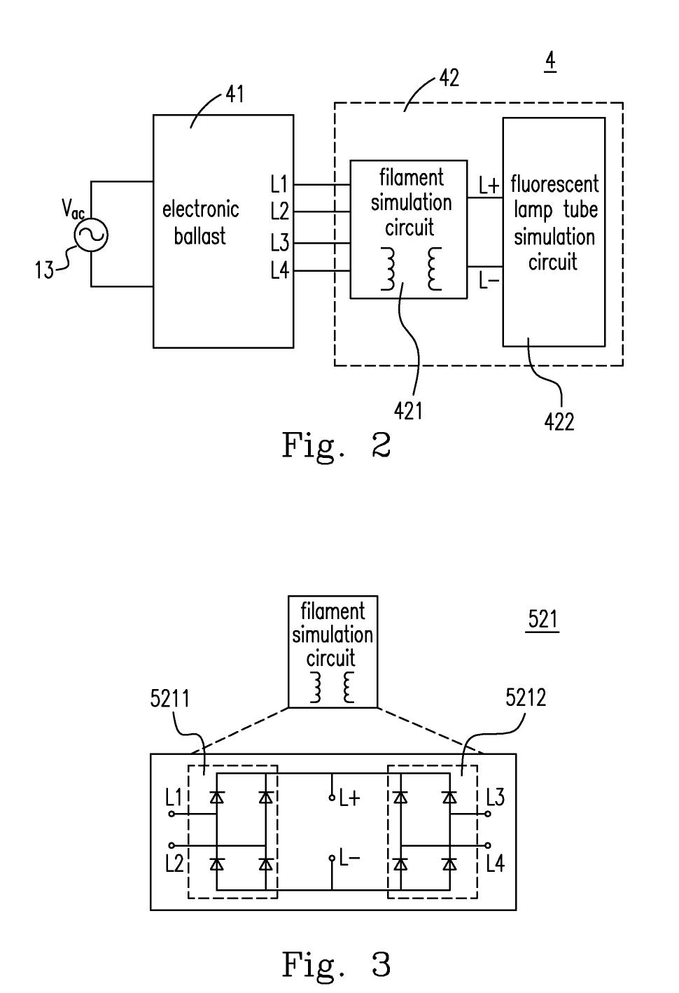

FIG. 2 shows a schematic diagram of a lamp 4 including an electronic ballast 41 and an LED replacement tube 42 according to the first preferred embodiment of the present invention. In FIG. 2, the electronic ballast 41 includes a first lamp tube connector with a first terminal and a second terminal (L1-L2), and a second lamp tube connector with a third terminal and a fourth terminal (L3-L4), the LED replacement tube 42 includes a filament simulation circuit 421 and a fluorescent lamp tube simulation circuit 422 electrically connected to the filament simulation circuit 421, the filament simulation circuit 421 is electrically connected to the first and the second lamp tube connectors (L1-L4), and the electronic ballast is electrically connected to an AC power source V_{ac}. The filament simulation circuit 421 according to the preferred embodiments of the present invention can be divided into the following types.

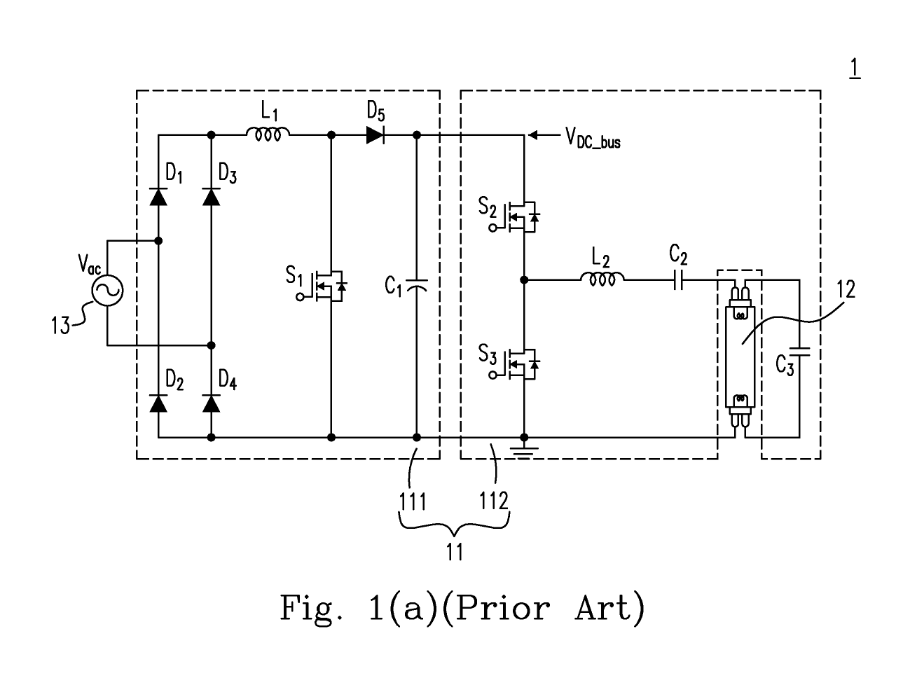

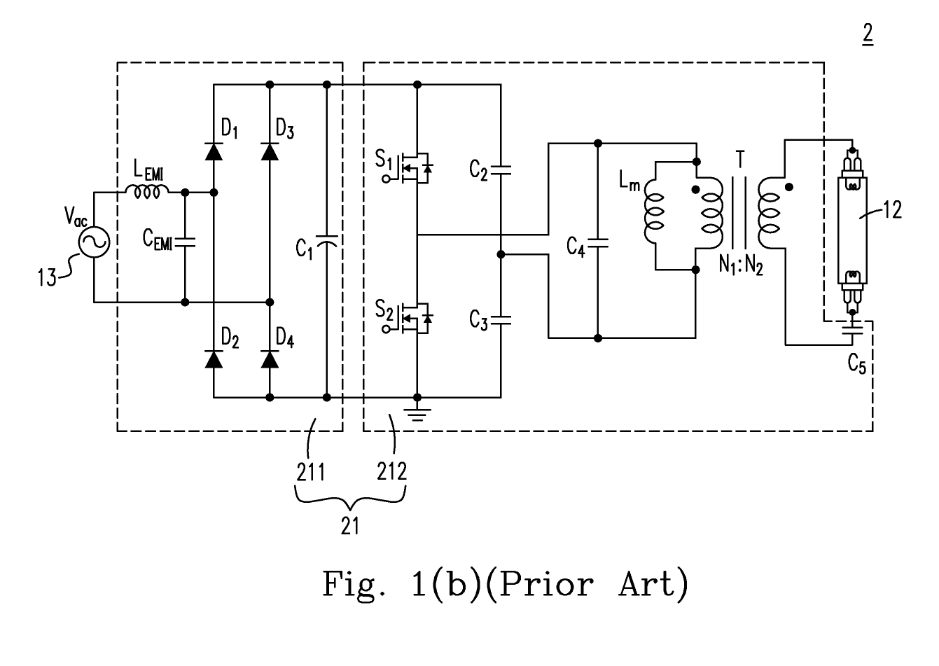

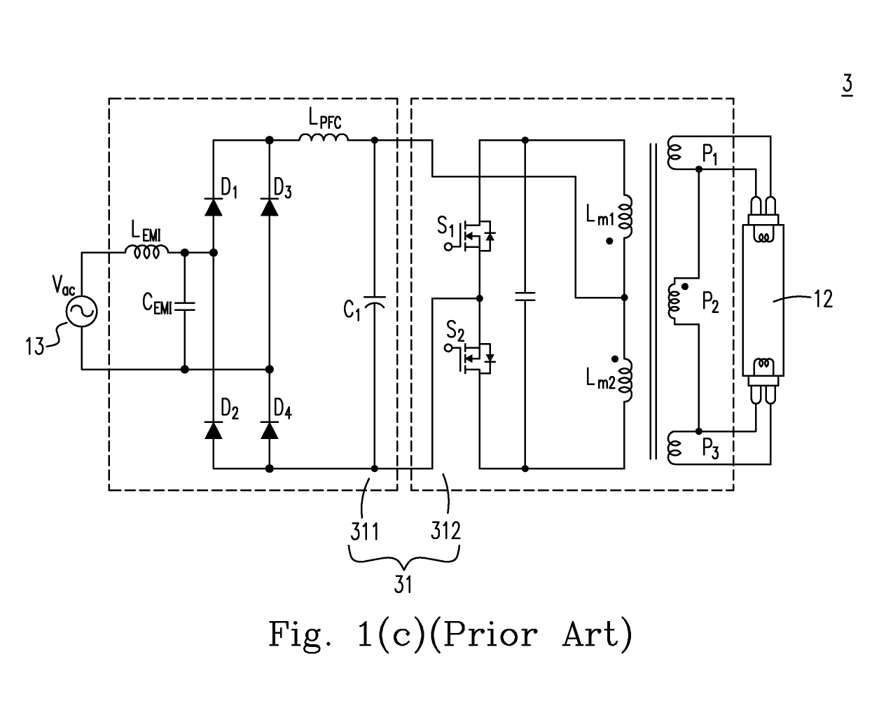

FIG. 3 is a schematic circuit diagram of a filament simulation circuit 521 according to the second preferred embodiment of the present invention. In FIG. 3, the filament simulation circuit 521 includes a first bridge rectifier circuit 5211 having four fast diodes and a second bridge rectifier circuit 5212 having four fast diodes, which is suitable for use with the three electronic ballasts as shown in FIGS. 1(a)-1(c). However, it is relatively not very suitable for use with the electronic ballast having the filament resistance detection circuit.

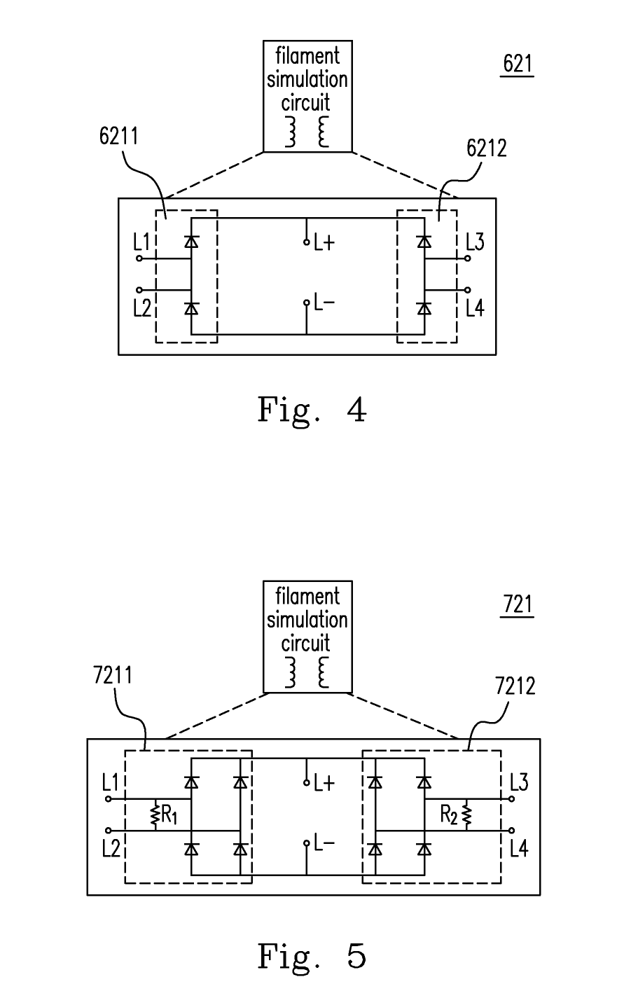

FIG. 4 is a schematic circuit diagram of a filament simulation circuit 621 according to the third preferred embodiment of the present invention. In FIG. 4, the filament simulation circuit 621 includes a first rectifier circuit 6211 having a dual-fast diode and a second rectifier circuit 6212 having a dual-fast diode, which is suitable for use with the preheat electronic ballast and the instant-start electronic ballast above. However, it is relatively not very suitable for use with the rapid-start electronic ballast above because the auxiliary windings heating the filaments can easily generate a large current resulting in damage to the ballast and extra power losses.

FIG. 5 is a schematic circuit diagram of a filament simulation circuit 721 according to the fourth preferred embodiment of the present invention. In FIG. 5, the filament simulation circuit 721 includes a first bridge rectifier circuit 7211 having a resistor electrically connected to the two input terminals thereof in parallel and a second bridge rectifier circuit 7212 having a resistor electrically connected to the two input terminals thereof in parallel. The first bridge rectifier circuit 7211 having the resistor electrically connected to the input terminals includes a first bridge rectifier having four fast diodes and a resistor R1 electrically connected to the first bridge rectifier in parallel. The second bridge rectifier circuit 7212 having the resistor electrically connected to the input terminals includes a second bridge rectifier having four fast diodes and a resistor R2 electrically connected to the second bridge rectifier in parallel. The filament simulation circuit 721 is suitable for use with the three electronic ballasts above. However, the resistances above were determined by considering the largest resistance acceptable to the filament simulation circuit 721 and the power losses caused by the auxiliary windings of the rapid-start electronic ballast.

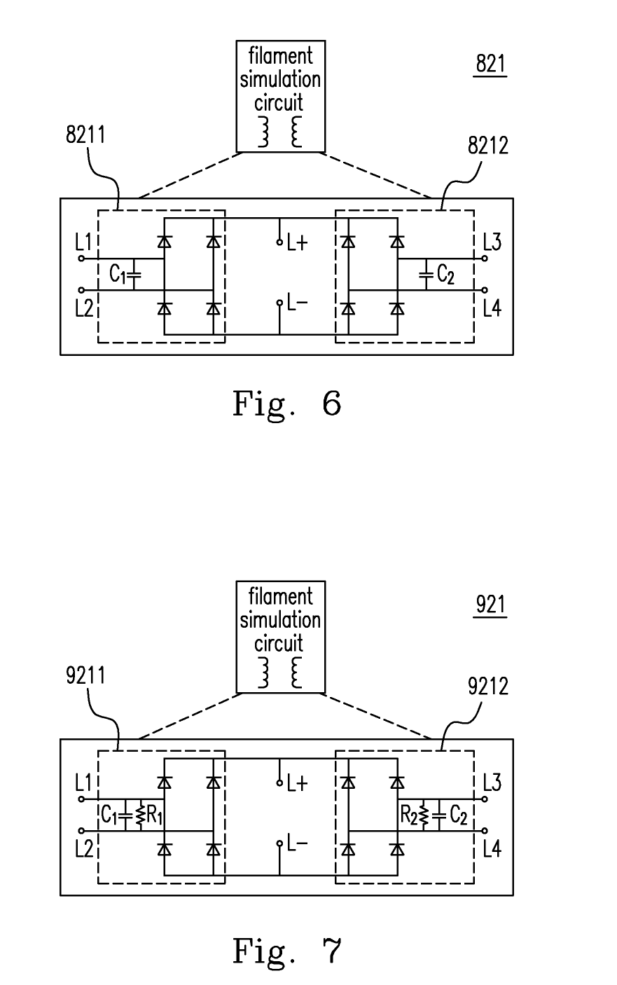

FIG. 6 is a schematic circuit diagram of a filament simulation circuit 821 according to the fifth preferred embodiment of the present invention. In FIG. 6, the filament simulation circuit 821 includes a first bridge rectifier circuit 8211 having a first bridge rectifier with four fast diodes and a capacitor C1 electrically connected to the first bridge rectifier in parallel and a second bridge rectifier circuit 8212 having a second bridge rectifier with four fast diodes and a capacitor C2 electrically connected to the second bridge rectifier in parallel, and is suitable for use with the three electronic ballasts above. The filament simulation circuit 821 can use large capacitors (C1 and C2) connected to the input terminals thereof to cope with the detection scheme of the electronic ballast 41, and avoid any extra power losses caused by the auxiliary windings when the rapid-start electronic ballast above is used.

FIG. 7 is a schematic circuit diagram of a filament simulation circuit 921 according to the sixth preferred embodiment of the present invention. In FIG. 7, the filament simulation circuit 921 includes a first bridge rectifier circuit 9211 having a first bridge rectifier with four fast diodes, and a resistor R1 and a capacitor C1 both electrically connected to the first bridge rectifier in parallel and a second bridge rectifier circuit 9212 having a second bridge rectifier with four fast diodes, and a resistor R2 and a capacitor C2 both electrically connected to the second bridge rectifier in parallel, which combines the characteristics of those in FIGS. 5 and 6 to avoid the use of capacitors with extra large capacitances and any extra power losses caused by the auxiliary windings when the rapid-start electronic ballast above is used.

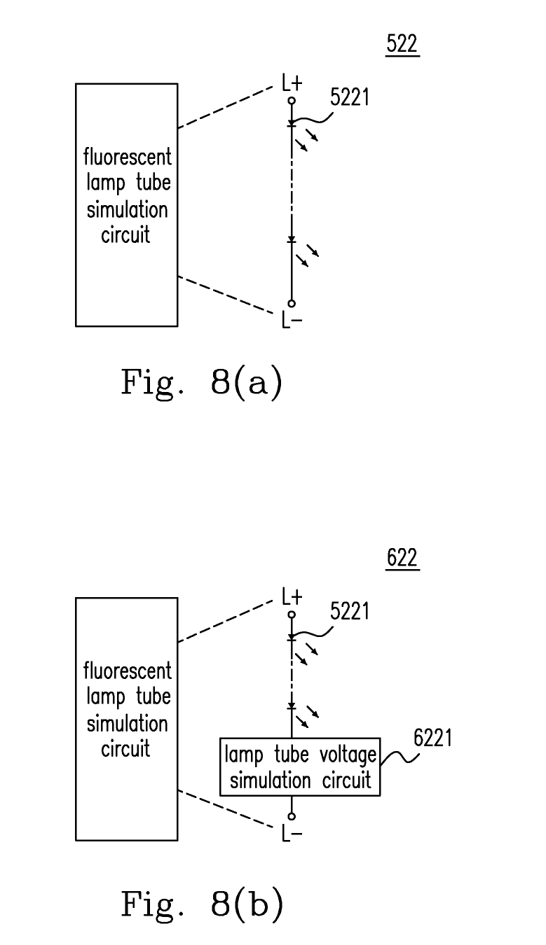

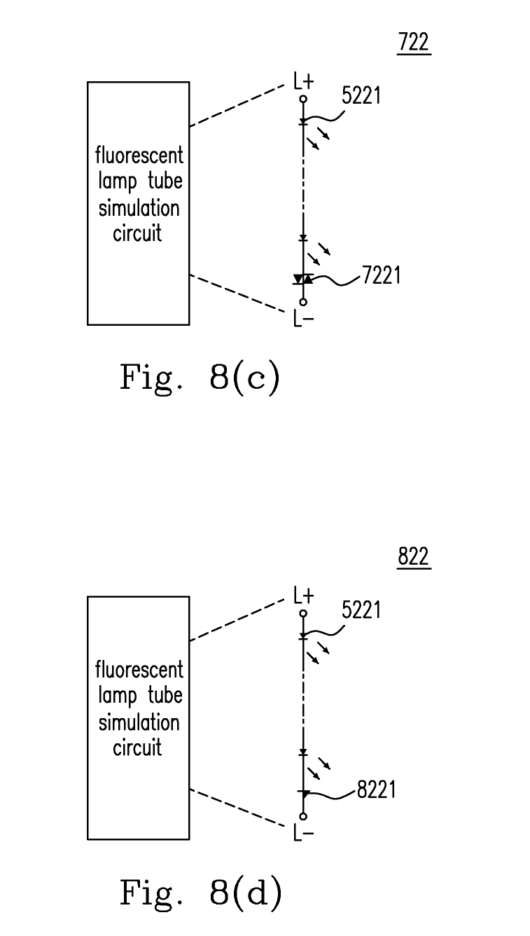

FIG. 8(a) shows a schematic circuit diagram of a fluorescent lamp tube simulation circuit 522 according to the seventh preferred embodiment of the present invention. The fluorescent lamp tube simulation circuit 522 has a first terminal L+ and a second terminal L−, and includes a plurality of LEDs 5221 electrically connected to one another in parallel or in series, and the fluorescent lamp tube simulation circuit 522 is used to simulate a stable lamp tube voltage of an existing fluorescent lamp tube.

FIG. 8(b) shows a schematic circuit diagram of a fluorescent lamp tube simulation circuit 622 according to the eighth preferred embodiment of the present invention. The fluorescent lamp tube simulation circuit 622 has a first terminal L+ and a second terminal L−, and includes a plurality of LEDs 5221 electrically connected to one another in parallel or in series and a tube voltage simulation circuit 6221. The fluorescent lamp tube simulation circuit 622 uses the plurality of LEDs 5221 electrically connected to one another in parallel or in series to simulate a stable lamp tube voltage of an existing fluorescent lamp tube, and uses the fluorescent lamp tube simulation circuit 6221 to simulate a starting high voltage for the lamp tube.

FIG. 8(c) shows a schematic circuit diagram of a fluorescent lamp tube simulation circuit 722 according to the ninth preferred embodiment of the present invention. The fluorescent lamp tube simulation circuit 722 has a first terminal L+ and a second terminal L−, and includes a plurality of LEDs 5221 electrically connected to one another in parallel or in series, and a tube voltage simulation circuit 7221 which is a DIAC. The fluorescent lamp tube simulation circuit 722 not only uses the plurality of LEDs 5221 electrically connected to one another in parallel or in series to simulate a stable lamp tube voltage of an existing fluorescent lamp tube, but also uses the fluorescent lamp tube simulation circuit 7221 (the DIAC) to simulate a starting high voltage for the lamp tube.

FIG. 8(d) shows a schematic circuit diagram of a fluorescent lamp tube simulation circuit 822 according to the tenth preferred embodiment of the present invention. The fluorescent lamp tube simulation circuit 822 has a first terminal L+ and a second terminal L−, and includes a plurality of LEDs 5221 electrically connected to one another in parallel or in series, and a tube voltage simulation circuit 8221 which is an SUS. The fluorescent lamp tube simulation circuit 822 not only uses the plurality of LEDs 5221 electrically connected to one another in parallel or in series to simulate a stable lamp tube voltage of an existing fluorescent lamp tube, but also uses the fluorescent lamp tube simulation circuit 8221 (the SUS) to simulate a starting high voltage for the lamp tube. The fluorescent lamp tube simulation circuits in FIGS. 8(a)-8(d) can not only be a DIAC or an SUS, but can also be one selected from a group consisting of an SIDAC, an SBS, an ASBS, an SAS, a Zener, and a semiconductor element including at least one of a MOSFET and a BJT. The fluorescent lamp tube voltage simulation circuit bears the starting high voltage for the lamp tube at the beginning, and the voltage across its two terminals decreases after the current flowing therethrough reaches a certain value to achieve a stable lamp tube voltage.

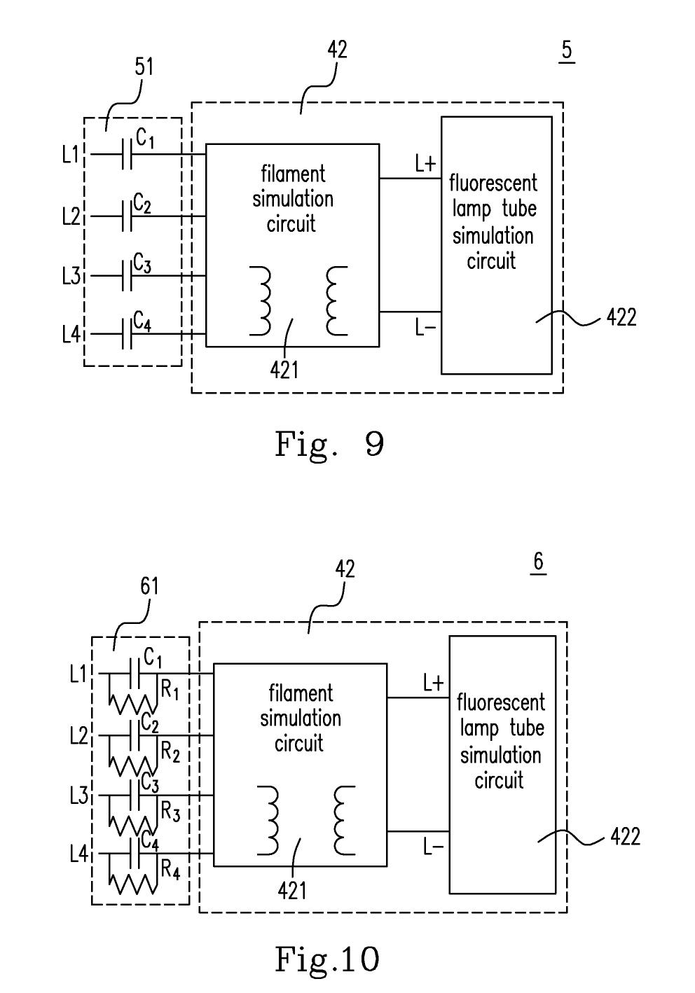

FIG. 9 shows a schematic circuit diagram of a lamp 5 including an LED replacement tube 42 adapted for use with an electronic ballast or an AC mains and an AC isolation circuit 51 according to the eleventh preferred embodiment of the present invention. In FIG. 9, the LED replacement tube 42 includes a filament simulation circuit 421 and a fluorescent lamp tube simulation circuit 422. The lamp 5 includes a voltage isolation circuit 51 having a first to a fourth capacitors C1-C4 electrically connected to the filament simulation circuit 421 in series. When the input terminals of the voltage isolation circuit 51 are electrically connected to the electronic ballast, the voltage isolation circuit 51 can be equivalent to a short-circuit without influencing the characteristics of the entire circuitry and the operations thereof because the operational frequency is quite high, and when the input terminals of the voltage isolation circuit 51 are electrically connected to the AC mains, the voltage isolation circuit 51 can be equivalent to an impedance because the operational frequency is quite low, and this impedance is used to bear a voltage value difference between the outputs of the AC mains and the electronic ballast such that the LED replacement tube 42 can have the same output power under these two different inputs.

FIG. 10 shows a schematic circuit diagram of a lamp 6 including an LED replacement tube 42 adapted for use with an electronic ballast or an AC mains and an AC isolation circuit 61 according to the twelfth preferred embodiment of the present invention. In FIG. 10, the LED replacement tube 42 also includes a filament simulation circuit 421 and a fluorescent lamp tube simulation circuit 422. The lamp 6 includes a voltage isolation circuit 61 having a first to a fourth capacitors C1-C4 and a first to a fourth resistors R1-R4 to form four RC circuits electrically connected in parallel and electrically connected to the filament simulation circuit 421 in series. When the input terminals of the voltage isolation circuit 61 are electrically connected to the electronic ballast, the voltage isolation circuit 61 can be equivalent to a short-circuit without influencing the characteristics of the entire circuitry and the operations thereof because the operational frequency is quite high, and when the input terminals of the voltage isolation circuit 61 are electrically connected to the AC mains, the voltage isolation circuit 61 can be equivalent to an impedance because the operational frequency is quite low, and this impedance is used to bear a difference in value between the first output voltage of the AC mains and the second output voltage of the electronic ballast such that the LED replacement tube 42 can have the same output power under these two different inputs.

### Embodiments

1. An LED tube adapted for use with an electronic ballast, comprising:
a filament simulation circuit including:
   a first rectifier circuit having at least one of a first instance of two fast diodes and a second instance of two super fast diodes; and
   a second rectifier circuit having at least one of a first instance of two fast diodes and a second instance of two super fast diodes, wherein the electronic ballast includes a first lamp tube connector with a first terminal and a second terminal, and a second lamp tube connector with a third terminal and a fourth terminal, the first rectifier circuit is electrically connected to the first and the second terminals and the second rectifier circuit is electrically connected to the third and the fourth terminals.

2. The LED tube according to Embodiment 1, wherein the first and the second rectifier circuits are a first and a second bridge rectifier circuits respectively, and each of the first and the second bridge rectifier circuits has one of a first instance of four fast diodes and a second instance of four super fast diodes.

3. The LED tube according to Embodiment 1 or 2, further comprising a fluorescent lamp tube simulation circuit, wherein the filament simulation circuit further includes a first resistor having a resistance less than 5 KΩ and a second resistor having a resistance less than 5 KΩ, the first and the second bridge rectifier circuits both include two input terminals and a first and a second output terminals, the first resistor is electrically connected to the two input terminals of the first bridge rectifier circuit in parallel, the second resistor is electrically connected to the two input terminals of the second bridge rectifier circuit in parallel, the fluorescent lamp tube simulation circuit includes a first and a second terminals, the first output terminals of the first and the second bridge rectifier circuits are electrically connected to the first terminal of the fluorescent lamp tube simulation circuit, and the second output terminals of the first and the second bridge rectifier circuits are electrically connected to the second terminal of the fluorescent lamp tube simulation circuit.

4. The LED tube according to any one of the above-mentioned Embodiments, wherein the filament simulation circuit further includes a first capacitor having a capacitance larger than 10 μF, and a second capacitor having a capacitance larger than 10 μF, the first and the second bridge rectifier circuits both include two input terminals, the first capacitor is electrically connected to the two input terminals of the first bridge rectifier circuit in parallel, and the second capacitor is electrically connected to the two input terminals of the second bridge rectifier circuit in parallel.

5. The LED tube according to any one of the above-mentioned Embodiments, wherein the filament simulation circuit further includes a first resistor having a resistance less than 5 KΩ, a second resistor having a resistance less than 5 KΩ, a first capacitor having a capacitance larger than 10 μF, and a second capacitor having a capacitance larger than 10 μF, the first and the second bridge rectifier circuits both include two input terminals, the first resistor and the first capacitor are electrically connected to the two input terminals of the first bridge rectifier circuit in parallel, and the second resistor and the second capacitor are electrically connected to the two input terminals of the second bridge rectifier circuit in parallel.

6. The LED tube according to any one of the above-mentioned Embodiments, further comprising a fluorescent lamp tube simulation circuit with a plurality of LEDs, each of which is electrically connected to another one in one of two states being in series and in parallel.

7. The LED tube according to any one of the above-mentioned Embodiments, further comprising a fluorescent lamp tube simulation circuit and a voltage isolation circuit with a first to a fourth capacitors, wherein one of the electronic ballast and the voltage isolation circuit is electrically connected to AC mains, the AC mains generate a first output voltage, the electronic ballast generates a second output voltage, when the electronic ballast receives the first output voltage, the first to the fourth capacitors are electrically connected between the first to the fourth terminals and the fluorescent lamp tube simulation circuit in series respectively, and when the voltage isolation circuit receives the first output voltage, the first and the second lamp tube connectors are electrically connected to the AC mains, and the voltage isolation circuit is used to bear a difference between the first output voltage and the second output voltage.

8. The LED tube according to any one of the above-mentioned Embodiments, wherein the voltage isolation circuit further includes a first to a fourth resistors electrically connected to the first to the fourth capacitors in parallel respectively, and each of the first to the fourth resistors is a charging resistor.

9. The LED tube according to any one of the above-mentioned Embodiments, wherein the first and the second rectifier circuits are a first dual-diode circuit with a first and a second diodes, and a second dual-diode circuit with a third and a fourth diodes respectively, each of the first to the fourth diodes has an anode and a cathode, the anode of the first diode, the cathode of the second diode, the first terminal and the second terminal are electrically connected, and the anode of the third diode, the cathode of the fourth diode, the third terminal and the fourth terminal are electrically connected.

10. The LED tube according to any one of the above-mentioned Embodiments, further comprising a fluorescent lamp tube simulation circuit with a first terminal and a second terminal, wherein the cathodes of the first and the third diodes are electrically connected to the first terminal of the fluorescent lamp tube simulation circuit, and the anodes of the second and the fourth diodes are electrically connected to the second terminal of the fluorescent lamp tube simulation circuit.

11. An LED tube adapted for use with an electronic ballast, comprising:
a filament simulation circuit electrically connected to the electronic ballast; and
a fluorescent lamp tube simulation circuit electrically connected to the filament simulation circuit and including:
   a plurality of LEDs; and
   a lamp tube voltage simulation circuit electrically connected to the plurality of LEDs in series.

12. The LED tube according to Embodiment 11, wherein each of the plurality of LEDs is electrically connected to another one in one of two states being in series and in parallel, the lamp tube voltage simulation circuit is one of a thyristor element and a semiconductor switch element, and the lamp tube voltage simulation circuit is one selected from a group consisting of a DIAC, an SUS, an SIDAC, an SBS, an ASBS, an SAS, a Zener, a MOSFET, and a BJT.

13. The LED tube according to Embodiment 11 or 12, wherein the filament simulation circuit and the fluorescent lamp tube simulation circuit form a simulation circuit, the electronic ballast operates under a specific operation mode, and the simulation circuit responds to the specific operation mode.

14. The LED tube according to any one of the above-mentioned Embodiments, wherein the specific operation mode includes a resistance detection mode used to detect a resistance of a filament of an existing fluorescent lamp tube, and a lamp tube voltage detection mode used to detect a tube voltage of the fluorescent lamp tube, the plurality of LEDs are electrically connected to one another in one of two states being in series and in parallel, the filament simulation circuit is used to provide a simulation datum of the resistance of the filament to respond to the resistance detection mode so as to present a first status showing that the resistance of the filament is normal, the fluorescent lamp tube simulation circuit uses the plurality of LEDs to provide a stable lamp tube voltage, and uses the lamp tube voltage simulation circuit to provide a starting high voltage for the lamp tube so as to respond to the lamp tube voltage detection mode accordingly to present a second status showing that the lamp tube voltage is normal such that the electronic ballast and the LED tube are both operating normally.

15. A controlling method for an LED tube adapted for use with an electronic ballast, comprising:
providing the electronic ballast having a specific operation mode and the LED tube having a simulation circuit; and
causing the simulation circuit to simulate a resistance of a filament of a fluorescent lamp tube and a lamp tube voltage so as to respond to the specific operation mode accordingly such that the LED tube operates normally.

16. The controlling method according to Embodiment 15, wherein the specific operation mode includes a resistance detection mode and a lamp tube voltage detection mode, and the simulation circuit includes a filament simulation circuit, and a fluorescent lamp tube simulation circuit having a lamp tube voltage simulation circuit and a plurality of LEDs electrically connected to one another in one of two states being in series and in parallel, further comprising:
causing the filament simulation circuit to provide a simulation datum of the resistance of the filament and to respond to the resistance detection mode accordingly so as to present a first status showing that the resistance of the filament is normal;
causing the fluorescent lamp tube simulation circuit to use the plurality of LEDs to provide a stable lamp tube voltage;
causing the lamp tube voltage simulation circuit to provide a starting high voltage for the lamp tube; and
responding to the lamp tube voltage detection mode according to the stable lamp tube voltage and the starting high voltage for the lamp tube so as to present a second status showing that the lamp tube voltage is normal such that the electronic ballast and the LED tube are both operating normally.

17. The controlling method according to Embodiment 15 or 16, wherein the specific operation mode includes a resistance detection mode and a lamp tube voltage detection mode, and the simulation circuit includes a filament simulation circuit and a fluorescent lamp tube simulation circuit having a lamp tube voltage simulation circuit and a plurality of LEDs electrically connected to one another in one of two states being in series and in parallel, further comprising:
causing the filament simulation circuit to provide a simulation datum of the resistance of the filament and to respond to the resistance detection mode accordingly so as to present a first status showing that the resistance of the filament is normal;
causing the fluorescent lamp tube simulation circuit to use the plurality of LEDs to provide a stable lamp tube voltage; and
responding to the lamp tube voltage detection mode according to the stable lamp tube voltage so as to present a second status showing that the lamp tube voltage is normal such that the electronic ballast and the LED tube are both operating normally.

According to the descriptions above, the present invention discloses an LED tube for use with an electronic ballast or AC mains to replace the fluorescent lamp tube with a basic configuration using the characteristics of the electronic ballast adapted for use with a dual-fast bridge rectifier without changing the circuitry, wherein the LED tube includes a filament simulation circuit and a fluorescent lamp tube simulation circuit, the filament simulation circuit comprises the basic configuration, a capacitor connected to the basic configuration in parallel, or a resistor connected to the basic configuration in parallel, and the fluorescent lamp tube simulation circuit comprises LEDs, or LEDs adapted for use with a tube voltage simulation circuit so as to respond to the filament detection scheme and the tube voltage detection scheme within the electronic ballast.

While the invention has been described in terms of what is presently considered to be the most practical and preferred embodiments, it is to be understood that the invention needs not be limited to the disclosed embodiments. Therefore, it is intended to cover various modifications and similar configuration included within the spirit and scope of the appended claims, which are to be accorded with the broadest interpretation so as to encompass all such modifications and similar structures.

What is claimed is:

1. An LED tube adapted for use with an electronic ballast, comprising:
a filament simulation circuit including:
a first rectifier circuit having at least one of a first instance of two fast diodes and a second instance of two super fast diodes; and
a second rectifier circuit having at least one of a first instance of two fast diodes and a second instance of two super fast diodes, wherein the electronic ballast includes a first lamp tube connector with a first terminal and a second terminal, and a second lamp tube connector with a third terminal and a fourth terminal, the first rectifier circuit is electrically connected to the first and the second terminals and the second rectifier circuit is electrically connected to the third and the fourth terminals.

2. The LED tube according to claim 1, wherein the first and the second rectifier circuits are a first and a second bridge rectifier circuits respectively, and each of the first and the second bridge rectifier circuits has one of a first instance of four fast diodes and a second instance of four super fast diodes.

3. The LED tube according to claim 2, further comprising a fluorescent lamp tube simulation circuit, wherein the filament simulation circuit further includes a first resistor having a resistance less than 5 KΩ and a second resistor having a resistance less than 5 KΩ, the first and the second bridge rectifier circuits both include two input terminals and a first and a second output terminals, the first resistor is electrically connected to the two input terminals of the first bridge rectifier circuit in parallel, the second resistor is electrically connected to the two input terminals of the second bridge rectifier circuit in parallel, the fluorescent lamp tube simulation circuit includes a first and a second terminals, the first output terminals of the first and the second bridge rectifier circuits are electrically connected to the first terminal of the fluorescent lamp tube simulation circuit, and the second output terminals of the first and the second bridge rectifier circuits are electrically connected to the second terminal of the fluorescent lamp tube simulation circuit.

4. The LED tube according to claim 2, wherein the filament simulation circuit further includes a first capacitor having a capacitance larger than 10 μF, and a second capacitor having a capacitance larger than 10 μF, the first and the second bridge rectifier circuits both include two input terminals, the first capacitor is electrically connected to the two input terminals of the first bridge rectifier circuit in parallel, and the second capacitor is electrically connected to the two input terminals of the second bridge rectifier circuit in parallel.

5. The LED tube according to claim 2, wherein the filament simulation circuit further includes a first resistor having a resistance less than 5 KΩ, a second resistor having a resistance less than 5 KΩ, a first capacitor having a capacitance larger than 10 μF, and a second capacitor having a capacitance larger than 10 μF, the first and the second bridge rectifier circuits both include two input terminals, the first resistor and the first capacitor are electrically connected to the two input terminals of the first bridge rectifier circuit in parallel, and the second resistor and the second capacitor are electrically connected to the two input terminals of the second bridge rectifier circuit in parallel.

6. The LED tube according to claim 1, further comprising a fluorescent lamp tube simulation circuit with a plurality of LEDs, each of which is electrically connected to another one in one of two states being in series and in parallel.

7. The LED tube according to claim 1, further comprising a fluorescent lamp tube simulation circuit and a voltage isolation circuit with a first to a fourth capacitors, wherein one of the electronic ballast and the voltage isolation circuit is electrically connected to AC mains, the AC mains generate a first output voltage, the electronic ballast generates a second output voltage, when the electronic ballast receives the first output voltage, the first to the fourth capacitors are electrically connected between the first to the fourth terminals and the fluorescent lamp tube simulation circuit in series respectively, and when the voltage isolation circuit receives the first output voltage, the first and the second lamp tube connectors are electrically connected to the AC mains, and the voltage isolation circuit is used to bear a difference between the first output voltage and the second output voltage.

8. The LED tube according to claim 7, wherein the voltage isolation circuit further includes a first to a fourth resistors electrically connected to the first to the fourth capacitors in parallel respectively, and each of the first to the fourth resistors is a charging resistor.

9. The LED tube according to claim 1, wherein the first and the second rectifier circuits are a first dual-diode circuit with a first and a second diodes, and a second dual-diode circuit with a third and a fourth diodes respectively, each of the first to the fourth diodes has an anode and a cathode, the anode of the first diode, the cathode of the second diode, the first terminal and the second terminal are electrically connected, and the anode of the third diode, the cathode of the fourth diode, the third terminal and the fourth terminal are electrically connected.

10. The LED tube according to claim 9, further comprising a fluorescent lamp tube simulation circuit with a first terminal and a second terminal, wherein the cathodes of the first and the third diodes are electrically connected to the first terminal of the fluorescent lamp tube simulation circuit, and the anodes of the second and the fourth diodes are electrically connected to the second terminal of the fluorescent lamp tube simulation circuit.

11. An LED tube adapted for use with an electronic ballast, comprising:
a filament simulation circuit electrically connected to the electronic ballast; and
a fluorescent lamp tube simulation circuit electrically connected to the filament simulation circuit and including:
a plurality of LEDs; and
a lamp tube voltage simulation circuit electrically connected to the plurality of LEDs in series.

12. The LED tube according to claim 11, wherein each of the plurality of LEDs is electrically connected to another one in one of two states being in series and in parallel, the lamp tube voltage simulation circuit is one of a thyristor element and a semiconductor switch element, and the lamp tube voltage simulation circuit is one selected from a group consisting of a DIAC, an SUS, an SIDAC, an SBS, an ASBS, an SAS, a Zener, a MOSFET, and a BJT.

13. The LED tube according to claim 11, wherein the filament simulation circuit and the fluorescent lamp tube simulation circuit form a simulation circuit, the electronic ballast operates under a specific operation mode, and the simulation circuit responds to the specific operation mode.

14. The LED tube according to claim 13, wherein the specific operation mode includes a resistance detection mode used to detect a resistance of a filament of an existing fluorescent lamp tube, and a lamp tube voltage detection mode used to detect a tube voltage of the fluorescent lamp tube, the plurality of LEDs are electrically connected to one another in one of two states being in series and in parallel, the filament simulation circuit is used to provide a simulation datum of the resistance of the filament to respond to the resistance detection mode so as to present a first status showing that the resistance of the filament is normal, the fluorescent lamp tube simulation circuit uses the plurality of LEDs to provide a stable lamp tube voltage, and uses the lamp tube voltage simulation circuit to provide a starting high voltage for the lamp tube so as to respond to the lamp tube voltage detection mode accordingly to present a second status showing that the lamp tube voltage is normal such that the electronic ballast and the LED tube are both operating normally.

15. A controlling method for an LED tube adapted for use with an electronic ballast, comprising:
providing the electronic ballast having a specific operation mode and the LED tube having a simulation circuit; and
causing the simulation circuit to simulate a resistance of a filament of a fluorescent lamp tube and a lamp tube voltage so as to respond to the specific operation mode accordingly such that the LED tube operates normally.

16. The controlling method according to claim 15, wherein the specific operation mode includes a resistance detection mode and a lamp tube voltage detection mode, and the simulation circuit includes a filament simulation circuit, and a fluorescent lamp tube simulation circuit having a lamp tube voltage simulation circuit and a plurality of LEDs electrically connected to one another in one of two states being in series and in parallel, further comprising:
causing the filament simulation circuit to provide a simulation datum of the resistance of the filament and to respond to the resistance detection mode accordingly so as to present a first status showing that the resistance of the filament is normal;
causing the fluorescent lamp tube simulation circuit to use the plurality of LEDs to provide a stable lamp tube voltage;
causing the lamp tube voltage simulation circuit to provide a starting high voltage for the lamp tube; and
responding to the lamp tube voltage detection mode according to the stable lamp tube voltage and the starting high voltage for the lamp tube so as to present a second status showing that the lamp tube voltage is normal such that the electronic ballast and the LED tube are both operating normally.

17. The controlling method according to claim 15, wherein the specific operation mode includes a resistance detection mode and a lamp tube voltage detection mode, and the simulation circuit includes a filament simulation circuit and a fluorescent lamp tube simulation circuit having a lamp tube voltage simulation circuit and a plurality of LEDs electrically connected to one another in one of two states being in series and in parallel, further comprising:
causing the filament simulation circuit to provide a simulation datum of the resistance of the filament and to respond to the resistance detection mode accordingly so as to present a first status showing that the resistance of the filament is normal;
causing the fluorescent lamp tube simulation circuit to use the plurality of LEDs to provide a stable lamp tube voltage; and
responding to the lamp tube voltage detection mode according to the stable lamp tube voltage so as to present a second status showing that the lamp are both operating normally.
